(19) United States
(12) Patent Application Publication
(10) Pub. No.: US 2018/0242363 A1
(43) Pub. Date: Aug. 23, 2018

(54) METHOD AND TRANSMITTER OF IMPLEMENTING MULTIPLE-CARRIER LISTEN-BEFORE TALK

(71) Applicant: ALCATEL LUCENT, Boulogne Billancourt (FR)

(72) Inventors: Jianguo Liu, Shanghai (CN); Yan Meng, Shanghai (CN); Tao Tao, Shanghai (CN); Gang Shen, Shanghai (CN); Junrong Gu, Shanghai (CN); Feng Han, Shanghai (CN); Sigen Ye, Shanghai (CN)

(73) Assignee: Alcatel Lucent, Boulogne Billancourt (FR)

(21) Appl. No.: 15/751,727

(22) PCT Filed: Jul. 26, 2016
(86) PCT No.: PCT/IB2016/001276

§ 371 Date: Feb. 9, 2018

(30) Foreign Application Priority Data
Aug. 10, 2015 (CN) 201510487343.X

(51) Int. Cl. H04W 74/08; H04W 72/02

(52) U.S. Cl. CPC H04W 74/0816; H04W 72/0453; H04W 72/02

(57) ABSTRACT

Embodiments of the present disclosure relate to a method and a transmitter of implementing multiple-carrier Listen-Before-Talk in a wireless communication system. The method comprises: selecting a carrier group from a plurality of carriers as a synchronization carrier; determining a transmission synchronization boundary based on an extended CCA performed on the synchronization carrier; performing an initial CCA for the plurality of carriers; and determining that transmission is to be performed on at least one of the plurality of carriers based on at least one of the result of the extended CCA and the result of the initial CCA. The embodiments according to the present disclosure require only performing eCCA on the carrier group selected as the synchronization carrier. Compared with Wi-Fi, the LTE system can compete with Wi-Fi more fairly, and compared with the traditional solution it is more possible to obtain some carriers in the unlicensed spectrum. Additionally, the channel resource usage efficiency on the unlicensed spectrum is enhanced significantly.

### TECHNOLOGY

The embodiments of the present disclosure relate to wireless network technology, and particularly to a method of implementing multiple-carrier Listen-Before-Talk in a wireless communication system, a transmitter of implementing multiple-carrier Listen-Before-Talk in a wireless communication system, and the user equipment and the base station comprising this transmitter.

### BACKGROUND

The amount of data traffic carried over cellular networks is expected to increase for many years. More and more spectrums are therefore needed for cellular operators to meet the increasing service demand. Therefore, a large available bandwidth of an unlicensed spectrum can be utilized for Licensed-Assisted Access Using LTE (LAA-LTE).

For LAA-LTE, the primary cell is always on a licensed carrier and multiple secondary cells may be operating in the unlicensed spectrum. In such case, each secondary cell could be configured and activated independently of other component carriers, and could also be independent from other carriers from a data transmission perspective. As the interference conditions on each carrier are different, eNB may transmit on the carrier if a clearance channel assessment (CCA) succeeds on that carrier. Due to RF leakage into adjacent carriers, when one LAA device is performing transmission on a carrier, the likelihood of Listen-Before-Talk (LBT) success in adjacent carriers of the same LAA device is minimal.

To solve the RF leakage issue, Qualcomm proposes a LBT procedure for multiple-carrier operation. FIG. 1 shows a schematic diagram 100 when performing channel competition according to the proposal of Qualcomm. As shown in Figure, the method is performed independently on each unlicensed carrier using a LBT synchronization boundary (LSB). Herein, after finishing a transmission, the transmitter performs an extended CCA and goes into self-deferral state independently on each carrier until the LSB. At the LSB, the self-deferral state node becomes active, and an initial CCA (iCCA) is performed on all the carriers for which the extended CCA (eCCA) procedure has previously completed and then the transmission on the subset of carriers, for which iCCA is successful, is started. The proposal can efficiently solve the adverse impact of RF leakage on LBT procedure for multiple-carrier operation on unlicensed spectrum as shown in FIG. 1.

In contrast, Wi-Fi nodes also perform the eCCA procedure, but only on the primary channel and only sense for 25 us just before the potential start of transmission on all the secondary channels. However, the proposal from Qualcomm need perform eCCA on each unlicensed carrier and can only start transmission after both eCCA countdown and iCCA are completed. As it is necessary to complete the countdown before transmission, the transmitter may have the risk of losing the carriers for which countdown hasn't been completed. In addition, the proposal from Qualcomm introduces an additional self-deferral state and chooses not to transmit data immediately until the LSB. Unlike the Wi-Fi, the transmitter wouldn't grab the channel immediately if the carrier is clear due to the self-deferral. As a consequence, this solution would result in unfair coexistence with Wi-Fi, and thus decrease the channel access opportunity and waste the channel resource for LAA.

Therefore, it's necessary to enhance the existing multiple-carrier LBT mechanism so as to ensure co-existence fairness with other nodes besides solving the adverse impact of RF leakage on LBT.

### SUMMARY

Thus, it's necessary to consider the impact of RF leakage on multi-carrier LBT operation of LAA node. In the embodiments of this disclosure, the solution is proposed for multiple-carrier LBT operation in LAA-LTE.

Based on the understanding of the prior art and the existing technical problem, the first aspect of the present disclosure provides a method of implementing multiple-carrier Listen-Before-Talk in a wireless communication system, which includes:

selecting a carrier group from a plurality of carriers as a synchronization carrier;
determining a transmission synchronization boundary based on an extended CCA performed on the synchronization carrier;
performing an initial CCA for the plurality of carriers; and
determining that transmission is to be performed on at least one of the plurality of carriers based on at least one of the result of the extended CCA and the result of the initial CCA.

According to the present disclosure, it only requires eCCA to be performed on the carrier group selected as the synchronization carrier. Thus, compared with Wi-Fi, the LTE system can compete with Wi-Fi more fairly, and compared with the traditional solution, such as Qualcomm's solution, it is more possible to obtain some carrier groups in the unlicensed spectrum. Additionally, compared with traditional LBT methods, the channel resource usage efficiency on the unlicensed spectrum in the method according to the present disclosure is enhanced significantly, since the method according to the present disclosure can perform data transmission just after eCCA and iCCA without going into self-deferral state.

In one embodiment according to the present disclosure, selecting a carrier group from a plurality of carriers as a synchronization carrier includes selecting the synchronization carrier semi-statically based on a first metric of each of the plurality of carriers.

Herein, the term “selecting semi-statically” means the apparatus of implementing the method of implementing multiple-carrier Listen-Before-Talk in a wireless communication system based on the present disclosure will perform the selection of the synchronization carrier unregularly or periodically, for example, perform one assessment every 50 ms and then perform the selection, or perform the assessment again and perform the selection again after each data transmission.

In one embodiment according to the present disclosure, the first metric includes a duty cycle of each of the plurality of carriers.

It is appreciated for those skilled in the art that a duty cycle of each of the plurality of carriers herein is just illustrated for example, but not for limitation. Other suitable channel assessment parameters are also possible, including, but not limited to, the channel quality parameter feedback from the receiver, CQI and etc., for example.

In one embodiment according to the present disclosure, a carrier group of the plurality of carriers with the lowest duty cycle is selected as the synchronization carrier.

In such way, selecting a carrier group of the plurality of carriers with the lowest duty cycle as the synchronization carrier can significantly enhance the success chance for the eCCA performed on the synchronization carrier, thereby the success probability of the LTE system for competing for the resource on the unlicensed spectrum is enhanced compared with the Wi-Fi system.

In one embodiment according to the present disclosure, a plurality of carriers is divided into a plurality of carrier groups based on an access requirement, and selecting a carrier group from a plurality of carriers as a synchronization carrier includes: selecting a carrier group dynamically as the synchronization carrier based on an extended CCA performed on each of the plurality of carrier groups.

Herein, selecting dynamically means the selection of the synchronization carrier can be performed actually based on the result of each performed eCCA. This kind of the selection manner can select the synchronization carrier more accurately.

In one embodiment according to the present disclosure, selecting a carrier group dynamically as the synchronization carrier based on an extended CCA performed on each of the plurality of carrier groups includes: selecting the carrier group which completes the extended CCA first as the synchronization carrier.

In such way, since the synchronization carrier is selected fastest, the eCCA procedure can be finished fastest and the usage for the wireless communication resource on the unlicensed spectrum can be maximized.

In one embodiment according to the present disclosure, performing an initial CCA for the plurality of carriers includes: performing the initial CCA before or after the transmission synchronization boundary.

In one embodiment according to the present disclosure, performing an initial CCA for the plurality of carriers includes: performing the initial CCA on carriers from the plurality of carriers except the synchronization carrier or on each of the plurality of carriers.

In one embodiment according to the present disclosure, when performing the initial CCA on carriers from the plurality of carriers except the synchronization carrier, determining that transmission is to be performed on at least one of the plurality of carriers based on at least one of the result of the extended CCA and the result of the initial CCA includes: determining that transmission is to be performed on the synchronization carrier based on the result of the extended CCA; and determining that transmission is to be performed on carriers from the plurality of carriers except the synchronization carrier based on the result of the initial CCA.

In one embodiment according to the present disclosure, performing an initial CCA for the plurality of carriers includes: performing the initial CCA on each of the plurality of carriers after the transmission synchronization boundary.

In one embodiment according to the present disclosure, determining that transmission is to be performed on at least one of the plurality of carriers based on at least one of the result of the extended CCA and the result of the initial CCA includes: determining that transmission is to be performed on at least one of the plurality of carriers based on the result of the initial CCA.

In one embodiment according to the present disclosure, the plurality of carriers includes carriers on an unlicensed spectrum.

In one embodiment according to the present disclosure, the synchronization carrier includes only one carrier or a plurality of carriers.

In addition, the second aspect of the present disclosure proposes a transmitter of implementing multiple-carrier Listen-Before-Talk in a wireless communication system, which includes:

a synchronization carrier selecting unit configured to select a carrier group from a plurality of carriers as a synchronization carrier;
a transmission synchronization boundary determining unit configured to determine a transmission synchronization boundary based on an extended CCA performed on the synchronization carrier;
a channel assessment unit configured to perform an initial CCA for the plurality of carriers; and
a transmission unit configured to determine that transmission is to be performed on at least one of the plurality of carriers based on at least one of the result of the extended CCA and the result of the initial CCA.

The transmitter according to the present disclosure only requires eCCA to be performed on the carrier group selected as the synchronization carrier. Thus, compared with Wi-Fi, the LTE system can compete with Wi-Fi more fairly, and compared with the traditional solution, such as Qualcomm's solution, it is more possible to obtain some carrier groups in the unlicensed spectrum. Additionally, compared with traditional LBT methods, the channel resource usage on the unlicensed spectrum in the method according to the present disclosure is enhanced significantly, since the method according to the present disclosure can perform data transmission just after eCCA and iCCA without going into self-deferral state.

In one embodiment according to the present disclosure, the synchronization carrier selecting unit is further configured to select the synchronization carrier semi-statically based on a first metric of each of the plurality of carriers.

Herein, the term “selecting semi-statically” means the apparatus of implementing the method of implementing multiple-carrier Listen-Before-Talk in a wireless communication system according to the present disclosure will perform the selection of the synchronization carrier unregularly or periodically, for example, perform one assessment every 50 ms and then perform the selection, or perform the assessment again and perform the selection again after each data transmission.

The first metric includes a duty cycle of each of the plurality of carriers. It is appreciated for those skilled in the art that a duty cycle of each of the plurality of carriers herein is just illustrated for example, but not for limitation. Other suitable channel assessment parameters are also possible, including, but not limited to, the channel quality parameter feedback from the receiver, CQI and etc., for example.

In one embodiment according to the present disclosure, the synchronization carrier selecting unit is further configured to select a carrier group of the plurality of carriers with the lowest duty cycle as the synchronization carrier. In such way, selecting a carrier group of the plurality of carriers with the lowest duty cycle as the synchronization carrier can significantly enhance the success chance for the eCCA performed on the synchronization carrier, thereby the success probability of the LTE system for competing for the resource on the unlicensed spectrum is enhanced compared with the Wi-Fi system.

In one embodiment according to the present disclosure, the synchronization carrier selecting unit is further configured to divide a plurality of carriers into a plurality of carrier groups based on an access requirement, and select a carrier group dynamically as the synchronization carrier based on an extended CCA performed on each of the plurality of carrier groups. Herein, selecting dynamically means the selection of the synchronization carrier can be performed actually based on the result of each performed eCCA. This kind of the selection manner can select the synchronization carrier more accurately.

In one embodiment according to the present disclosure, the synchronization carrier selecting unit is further configured for selecting the carrier group which completes the extended CCA first as the synchronization carrier. In such way, since the synchronization carrier is selected fastest, the eCCA procedure can be finished fastest and the usage for the wireless communication resource on the unlicensed spectrum can be maximized.

In one embodiment according to the present disclosure, the channel assessment unit is further configured to perform the initial CCA on carriers from the plurality of carriers except the synchronization carrier before the transmission synchronization boundary.

In one embodiment according to the present disclosure, when performing the initial CCA on carriers from the plurality of carriers except the synchronization carrier, the transmitting unit is further configured to: determine that transmission is to be performed on the synchronization carrier based on the result of the extended CCA; and determining that transmission is to be performed on carriers from the plurality of carriers except the synchronization carrier based on the result of the initial CCA.

In one embodiment according to the present disclosure, the channel assessment unit is further configured to perform the initial CCA on each of the plurality of carriers after the transmission synchronization boundary.

In one embodiment according to the present disclosure, the channel assessment unit is further configured to determine that transmission is to be performed on at least one of the plurality of carriers based on the result of the initial CCA.

In one embodiment according to the present disclosure, the plurality of carriers includes carriers on an unlicensed spectrum. In one embodiment according to the present disclosure, the synchronization carrier includes only one carrier or a plurality of carriers.

Further, the third aspect of the present disclosure provides a base station, wherein the base station includes a transmitter according to the second aspect of the present disclosure.

Finally, the fourth aspect of the present disclosure provides user equipment, wherein the user equipment includes a transmitter according to the second aspect of the present disclosure.

The method, transmitter, user equipment and base station based on the present disclosure can enable the LTE system to more fairly compete with the Wi-Fi system for the wireless communication resource on the unlicensed spectrum, and enhance the wireless communication resource usage efficiency on the unlicensed spectrum.

### BRIEF DESCRIPTION OF THE DRAWINGS

Other features, objects and advantages of the invention will become more apparent upon review of the following detailed description of non-limiting embodiments taken with reference to the drawings in which:

FIG. 1 shows a schematic diagram 100 of a LBT method with synchronization across carriers in prior art;

FIG. 2 shows a flowchart 200 of a method of implementing multiple-carrier Listen-Before-Talk in a wireless communication system according to one embodiment of the present disclosure;

FIG. 3 shows a schematic diagram 300 of one embodiment of a method of implementing multiple-carrier Listen-Before-Talk in a wireless communication system according to one embodiment of the present disclosure;

FIG. 4 shows a schematic diagram 400 of another embodiment of a method of implementing multiple-carrier Listen-Before-Talk in a wireless communication system according to one embodiment of the present disclosure;

FIG. 5 shows a schematic diagram 500 of another embodiment of a method of implementing multiple-carrier Listen-Before-Talk in a wireless communication system according to one embodiment of the present disclosure;

FIG. 6 shows a schematic diagram 600 of another embodiment of a method of implementing multiple-carrier Listen-Before-Talk in a wireless communication system according to one embodiment of the present disclosure; and

FIG. 7 shows a schematic diagram 700 of one embodiment of a transmitter of implementing multiple-carrier Listen-Before-Talk in a wireless communication system according to one embodiment of the present disclosure.

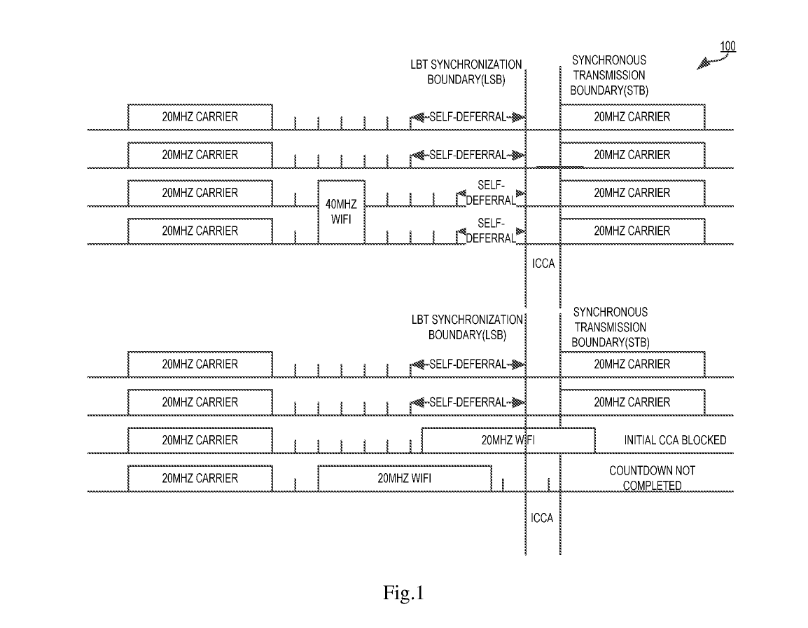

In the drawings, identical or like reference numerals denote identical or corresponding components or features throughout the different figures.

### DETAILED DESCRIPTION

Detailed description of preferred embodiments will be given below with reference to the drawings constituting a part of the disclosure. The drawings exemplarily illustrate particular embodiments, in which the disclosure can be practiced. The exemplary embodiments are not intended to exhaust all the embodiments of the disclosure. As can be appreciated, other embodiments can be possible or structural or logical modifications can be made without departing from the scope of the disclosure. Thus the following detailed description is not intended to be limiting, and the scope of the disclosure will be defined as in the appended claims.

In the scope of the present disclosure, the term “a carrier group” can only include one carrier, and can also include a plurality of carriers, of course. The principle that a carrier group is taken as a plurality of carriers is identical with the principle that a carrier is taken as a plurality of carriers. In the following, the illustration is given based on the example in which a carrier group includes a carrier. However, the protection scope of the present disclosure is not limited to the situation where the carrier group includes only one carrier, and of course includes the situation where the carrier group includes a plurality of carriers which is emphasized in claims.

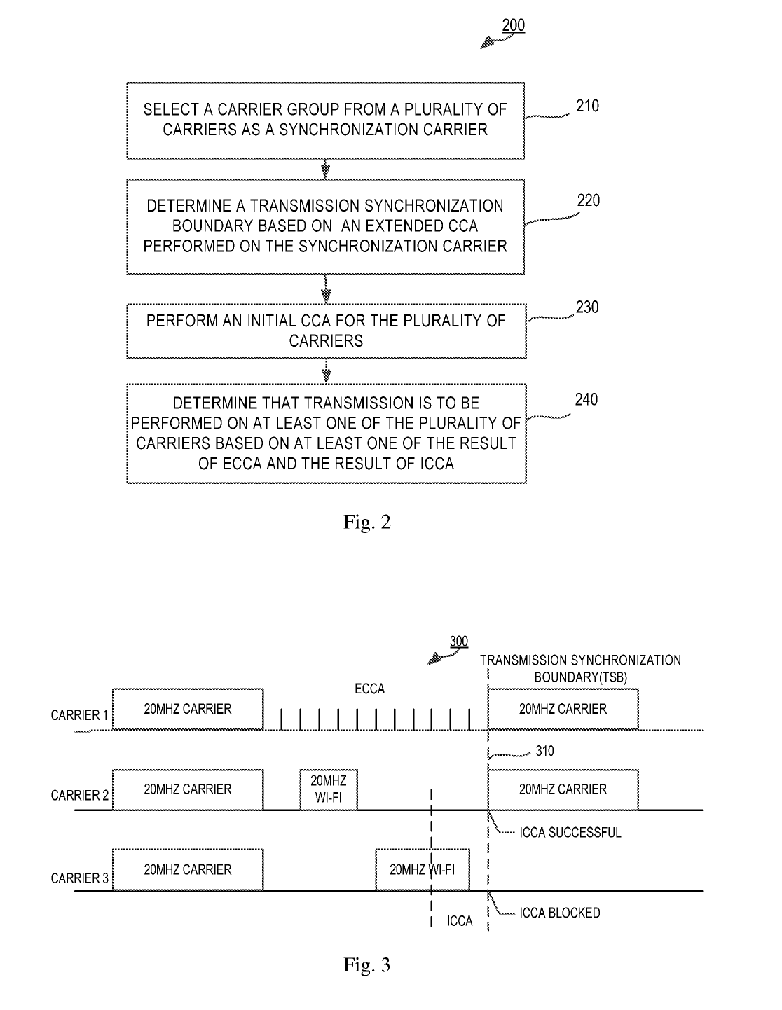

FIG. 2 shows a flowchart 200 of a method of implementing multiple-carrier Listen-Before-Talk in a wireless communication according to one embodiment of the present disclosure. As shown in the Figure, the method according to the present invention includes the following steps, that is: first, selecting a carrier group from a plurality of carriers as a synchronization carrier; then determining a transmission synchronization boundary based on an extended CCA performed on the synchronization carrier; and performing an initial CCA for the plurality of carriers; finally, determining that transmission is to be performed on at least one of the plurality of carriers based on at least one of the result of the extended CCA and the result of the initial CCA.

FIG. 3 shows a schematic diagram 300 of one embodiment of a method of implementing multiple-carrier Listen-Before-Talk in a wireless communication system according to one embodiment of the present disclosure. As shown in the figure, the unlicensed spectrum includes three carriers, for example. Different from the prior art in which the eCCA is performed on each carrier independently respectively, in the embodiment of the present disclosure, the eCCA is only performed on one carrier, such as carrier 1, and the eCCA is not performed on carrier 2 and carrier 3.

In the example 300 in FIG. 3, after determining carrier 1 as the synchronization carrier, the transmission synchronization boundary (TSB, (a multiple carrier synchronization boundary (MCSB) when multiple carrier groups are present)) can be determined, which is marked with the reference numeral 310 in FIG. 3. Then, in the example in FIG. 3, except the carrier 1, which is selected as the synchronization carrier, the iCCA is performed on carrier 2 and carrier 3 before TSB. In this example, the result of the eCCA performed on the synchronization carrier, that is carrier 1, is successful, the result of the iCCA on carrier 2 is also successful, but the result of the iCCA on carrier 3 is blocked due to the existence of Wi-Fi in the period in which iCCA is performed. At this point, according to the results above, the method will perform transmission only on carrier 1 and carrier 2, but not on carrier 3.

According to the present disclosure, it only requires eCCA to be performed on the carrier group selected as the synchronization carrier. Thus, compared with Wi-Fi, the LTE system can compete with Wi-Fi more fairly, and compared with the traditional solution, such as Qualcomm's solution, it is more possible to obtain some carrier groups in the unlicensed spectrum. Additionally, compared with traditional LBT methods, the channel resource usage efficiency on the unlicensed spectrum in the method according to the present disclosure is enhanced significantly, since the method according to the present disclosure can perform data transmission just after eCCA and iCCA without going into self-deferral state.

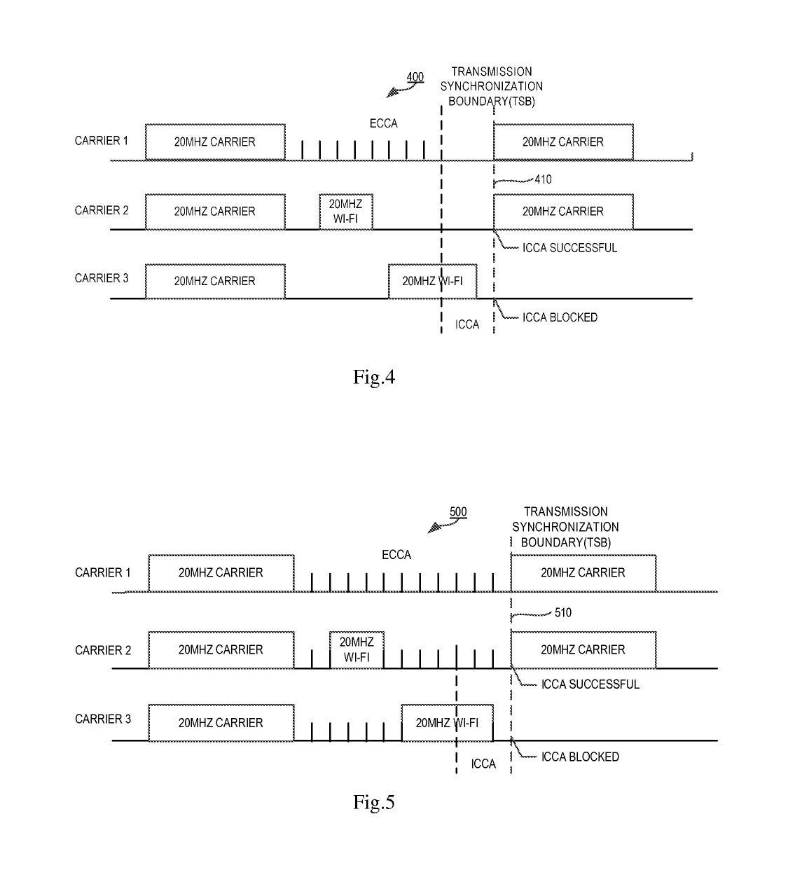

FIG. 4 shows a schematic diagram 400 of another embodiment of a method of implementing multiple-carrier Listen-Before-Talk in a wireless communication system according to one embodiment of the present disclosure. As shown in the Figure, different from FIG. 3, in the example 400 in FIG. 4, iCCA is performed after TSB (a multiple carrier synchronization boundary (MCSB) when multiple carrier groups are present). Now, in addition to the iCCA originally performed on carrier 2 and carrier 3, the iCCA is also performed on carrier 1. Finally, the result of the eCCA performed on the synchronization carrier, that is carrier 1, is successful, the result of the iCCA on carrier 2 is also successful, but the result of the iCCA on carrier 3 is blocked due to the existence of Wi-Fi in the period in which iCCA is performed. At this point, according to the results above, the method will perform transmission only on carrier 1 and carrier 2, but not on carrier 3.

In the embodiments in above FIGS. 3 and 4, selecting a carrier group from a plurality of carriers as a synchronization carrier includes: selecting the synchronization carrier semi-statically baased on a first metric of each of the plurality of carriers. Herein, the term “selecting semi-statically” means the apparatus of implementing the method of implementing multiple-carrier Listen-Before-Talk in a wireless communication system according to the embodiments of the present disclosure will perform the selection of the synchronization carrier unregularly or periodically, for example, perform one assessment every 50 ms and then perform the selection, or perform the assessment again and perform the selection again after each data transmission. It is appreciated for those skilled in the art that the first metric includes a duty cycle of the each carrier in the plurality of carriers. Herein, a duty cycle of the each carrier in the plurality of carriers herein is just illustrated for example, but not for limitation. Other suitable channel assessment parameters are also possible, including, but not limited to, the channel quality parameter feedback from the receiver, CQI and etc., for example. Preferably, a carrier group of the plurality of carriers with the lowest duty cycle is selected as the synchronization carrier. In such way, selecting a carrier group of the plurality of carriers with the lowest duty cycle as the synchronization carrier can significantly enhance the success chance for the eCCA performed on the synchronization carrier, thereby the success probability of the LTE system for competing for the resource on the unlicensed spectrum is enhanced compared with Wi-Fi system.

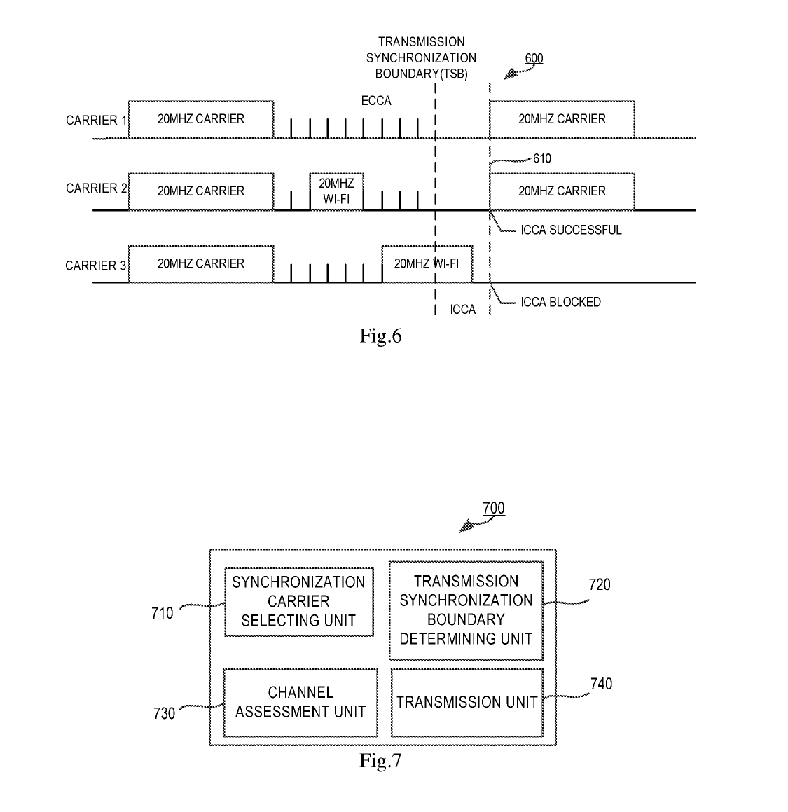

Different from selecting the synchronization carrier semi-statically in the above FIGS. 3 and 4, the detail embodiments in which a carrier group is selected as the synchronization carrier dynamically will be described with reference to FIGS. 5 and 6. FIG. 5 shows a schematic diagram 500 of another embodiment of a method of implementing multiple-carrier Listen-Before-Talk in a wireless communication system according to one embodiment of the present disclosure. And FIG. 6 shows a schematic diagram 600 of another embodiment of a method of implementing multiple-carrier Listen-Before-Talk in a wireless communication system according to one embodiment of the present disclosure. Herein, a carrier group is selected as the synchronization carrier dynamically according to the eCCA performed on each of the plurality of carrier groups. Herein, selecting dynamically means the selection of the synchronization carrier can be performed actually baased on the result of each implemented eCCA. This kind of the selection manner can select the synchronization carrier more accurately. Wherein the carrier group which completes the extended CCA first is selected advantageously as the synchronization carrier. In such way, since the synchronization carrier is selected fastest, the eCCA procedure can be finished fastest and the usage for the wireless communication resource on the unlicensed spectrum can be maximized.

In one embodiment in the present disclosure, performing an initial CCA for the plurality of carriers includes: performing the initial CCA on carriers from the plurality of carriers except the synchronization carrier or on each of the plurality of carriers.

In one embodiment in the present disclosure, performing an initial CCA for the plurality of carriers includes: performing the initial CCA before or after the transmission synchronization boundary.

Specifically, FIG. 5 shows this kind of embodiment. As shown in FIG. 5, according to the eCCA performed on carrier 1, carrier 2 and carrier 3, carrier 1, which first completed this procedure, is selected as the synchronization carrier, and then the transmission synchronization boundary (TSB, (a multiple carrier synchronization boundary (MCSB) when multiple carrier groups are present)) can be determined, which is marked as the reference numeral 510 in FIG. 5. Then, in the example in FIG. 5, except the carrier 1, which is selected as the synchronization carrier, the iCCA is performed on carrier 2 and carrier 3 before TSB. In this example, the result of the eCCA performed on the synchronization carrier, that is carrier 1, is successful, the result of the iCCA on carrier 2 is also successful, but the result of the iCCA on carrier 3 is blocked due to the existence of Wi-Fi in the period in which iCCA is performed. At this point, according to the results above, the method will perform transmission only on carrier 1 and carrier 2, but not on carrier 3.

In a further embodiment in the present disclosure, the iCCA is performed on each carrier among the plurality of carriers after the TSB. FIG. 6 shows a kind of this embodiment. Specifically, FIG. 6 shows a kind of this embodiment. As shown in FIG. 6, according to the eCCA performed on carrier 1, carrier 2 and carrier 3, carrier 1, which first completed this procedure, is selected as the synchronization carrier, and then the transmission synchronization boundary (TSB, (a multiple carrier synchronization boundary (MCSB) when multiple carrier groups are present)) can be determined, which is marked as the reference numeral 610 in FIG. 6. Then, in the example shown in FIG. 6, the iCCA is performed on carrier 1, which is selected as the synchronization carrier, carrier 2 and carrier 3 respectively after TSB. In this example, the result of the eCCA performed on the synchronization carrier, that is carrier 1, is successful, the result of the iCCA on carrier 2 is also successful, but the result of the iCCA on carrier 3 is blocked due to the existence of Wi-Fi in the period in which iCCA is performed. At this point, according to the results above, the method will perform transmission only on carrier 1 and carrier 2, but not on carrier 3.

In one embodiment in the present disclosure, the method further comprises: dividing the plurality of carriers into a plurality of carrier groups based on an access requirement and the plurality of carriers includes carriers on the unlicensed spectrum.

Further, the embodiment of the present disclosure provides a transmitter of implementing multiple-carrier Listen-Before-Talk in a wireless communication system. FIG. 7 shows a schematic diagram 700 of one embodiment of a transmitter of implementing multiple-carrier Listen-Before-Talk in a wireless communication system according to one embodiment of the present disclosure. As shown in the Figure, the transmitter 700 comprises:

a synchronization carrier selecting unit 710 configured to select a carrier group from a plurality of carriers as a synchronization carrier;
a transmission synchronization boundary determining unit 720 configured to determine a transmission synchronization boundary based on an extended CCA performed on the synchronization carrier;
a channel assessment unit 730 configured to implement an initial CCA for the plurality of carriers; and
a transmission unit 740 configured to determine that transmission is to be performed on at least one of the plurality of carriers based on at least one of the result of the extended CCA and the result of the initial CCA.

The transmitter according to the present disclosure only requires eCCA to be performed on the carrier group selected as the synchronization carrier. Thus, compared with Wi-Fi, the LTE system can compete with Wi-Fi more fairly, and compared with the traditional solution, such as Qualcomm's solution, it is more possible to obtain some carrier groups in the unlicensed spectrum. Additionally, compared with traditional LBT methods, the channel resource usage on the unlicensed spectrum in the method according to the present disclosure is enhanced significantly, since the method according to the present disclosure can perform data transmission just after eCCA and iCCA without going into self-deferral state.

In one embodiment according to the present disclosure, the synchronization carrier selecting unit is further configured to select the synchronization carrier semi-statically based on a first metric of each of the plurality of carriers. The first metric includes a duty cycle of each of the plurality of carriers. It is appreciated for those skilled in the art that a duty cycle of each of the plurality of carriers herein is just illustrated for example, but not for limitation. Other suitable channel assessment parameters are also possible, including, but not limited to, the channel quality parameter feedback from the receiver, CQI and etc., for example.

In one embodiment according to the present disclosure, the synchronization carrier selecting unit 710 is further configured to select a carrier group of the plurality of carriers with the lowest duty cycle as the synchronization carrier. In such way, selecting a carrier group of the plurality of carriers with the lowest duty cycle as the synchronization carrier can significantly enhance the success chance for the eCCA performed on the synchronization carrier, thereby the success probability of the LTE system for competing for the resource on the unlicensed spectrum is enhanced compared with Wi-Fi system.

In one embodiment according to the present disclosure, the synchronization carrier selecting unit 710 is further configured to select a carrier group dynamically as the synchronization carrier based on an extended CCA performed on each of the plurality of carrier groups. Herein, selecting dynamically means the selection of the synchronization carrier can be performed actually according to the result of each performed eCCA. This kind of the selection manner can select the synchronization carrier more accurately.

In one embodiment according to the present disclosure, the synchronization carrier selecting unit 710 is further configured to select the carrier group which completes the extended CCA first as the synchronization carrier. In such way, since the synchronization carrier is selected fastest, the eCCA procedure can be finished fastest and the usage for the wireless communication resource on the unlicensed spectrum can be maximized.

In one embodiment according to the present disclosure, the carrier assessment unit 730 is further configured to perform the initial CCA on carriers from the plurality of carriers except the synchronization carrier before the transmission synchronization boundary.

In one embodiment according to the present disclosure, when performing the initial CCA on carriers from the plurality of carriers except the synchronization carrier, the transmitting unit 740 is further configured to: determine that transmission is to be performed on the synchronization carrier according to the result of the extended CCA; and determine that transmission is to be performed carriers from the plurality of except the synchronization carrier based on the result of the initial CCA.

In one embodiment according to the present disclosure, the channel assessment unit 730 is further configured to perform the initial CCA on each of the plurality of carriers after the transmission synchronization boundary.

In one embodiment according to the present disclosure, the channel assessment unit 740 is further configured to determine that transmission is to be performed on at least one of the plurality of carriers based on the result of the initial CCA.

In one embodiment according to the present disclosure, the transmitter 700 is further configured to divide the plurality of carriers into a plurality of carrier groups based on an access requirement and the plurality of carriers include carriers on the unlicensed spectrum. In one embodiment according to the present disclosure, the synchronization carrier includes only one carrier or a plurality of carriers.

Those skilled in the art shall appreciate that the disclosure apparently will not be limited to the foregoing exemplary embodiments and can be embodied in other specific forms without departing from the spirit or essence of the disclosure. Accordingly, the embodiments shall be construed anyway to be exemplary and non-limiting. Moreover, apparently the term “comprising” will not preclude another element(s) or step(s), and the term “a” or “an” will not preclude plural. A plurality of elements stated in an apparatus claim can alternatively be embodied as a single element. The terms “first”, “second”, etc., are intended to designate a name but not to suggest any specific order.

I/We claim:

1. A method of implementing multiple-carrier Listen-Before-Talk in a wireless communication system comprising:
selecting a carrier group from a plurality of carriers as a synchronization carrier;
determining a transmission synchronization boundary based on an extended clearance channel assessment (CCA) performed on the synchronization carrier;
performing an initial CCA for the plurality of carriers; and
determining, based on at least one of a result of the extended CCA and a result of the initial CCA, that transmission is to be performed on at least one of the plurality of carriers.

2. The method according to claim 1, wherein selecting a carrier group from a plurality of carriers as a synchronization carrier comprises:
selecting the synchronization carrier semi-statically based on a first metric of each of the plurality of carriers.

3. The method according to claim 2, wherein the first metric includes a duty cycle of each of the plurality of carriers.

4. The method according to claim 3, wherein a carrier group of the plurality of carriers with the lowest duty cycle is selected as the synchronization carrier.

5. The method according to claim 1, further comprising:
dividing the plurality of carriers into a plurality of carrier groups based on an access requirement, and
wherein selecting a carrier group from the plurality of carriers as a synchronization carrier comprises:
selecting a carrier group dynamically as the synchronization carrier based on an extended CCA performed on each of the plurality of carrier groups.

6. The method according to claim 5, wherein selecting a carrier group dynamically as the synchronization carrier based on an extended CCA performed on each of the plurality of carrier groups comprises:
selecting the carrier group which first completes the extended CCA as the synchronization carrier.

7. The method according to claim 1, wherein performing an initial CCA for the plurality of carriers comprises:
performing the initial CCA before the transmission synchronization boundary.

8. The method according to claim 1, wherein performing an initial CCA for the plurality of carriers comprises:
performing the initial CCA after the transmission synchronization boundary.

9. The method according to claim 1, wherein performing an initial CCA for the plurality of carriers comprises:
performing the initial CCA on carriers from the plurality of carriers other than the synchronization carrier, or on each of the plurality of carriers.

10. The method according to claim 9, wherein when performing the initial CCA on carriers from the plurality of carriers other than the synchronization carrier, the determining that transmission is to be performed on at least one of the plurality of carriers comprises:
determining, based on the result of the extended CCA, that transmission is to be performed on the synchronization carrier; and
determining, based on the result of the initial CCA, that transmission is to be performed on carriers from the plurality of carriers except the synchronization carrier.

11. The method according to claim 10, wherein the determining that transmission is to be performed on at least one of the plurality of carriers comprises:
determining, based on the result of the initial CCA, that transmission is to be performed on at least one of the plurality of carriers.

12. The method according to claim 1, wherein the plurality of carriers includes carriers on an unlicensed spectrum.

13. A transmitter for implementing multiple-carrier Listen-Before-Talk in a wireless communication system comprising:
a synchronization carrier selecting unit configured to select a carrier group from a plurality of carriers as a synchronization carrier;
a transmission synchronization boundary determining unit configured to determine a transmission synchronization boundary based on an extended clearance channel assessment (CCA) performed on the synchronization carrier;
a channel assessment unit configured to perform an initial CCA for the plurality of carriers; and
a transmission unit configured to determine, based on at least one of a result of the extended CCA and a result of the initial CCA, that transmission is to be performed on at least one of the plurality of carriers.

14. Abase station including the transmitter according to claim 13.

15. User equipment including the transmitter according to claim 13.
